(19) United States
(12) Patent Application Publication
(10) Pub. No.: US 2022/0318124 A1
(43) Pub. Date: Oct. 6, 2022

(54) SYSTEM AND METHOD FOR FINANCIAL MANAGEMENT OF CLOUD COMPUTING ASSETS

(71) Applicant: Amadis Technologies Inc., Princeton, NJ (US)

(72) Inventors: Ashwin Mathukumar, Princeton, NJ (US); Suhan Selvan, Chennai (IN); Guhan Palanisamy, Chennai (IN)

(73) Assignee: Amadis Technologies Inc.

(21) Appl. No.: 17/218,291

(22) Filed: Mar. 31, 2021

(51) Int. Cl. G06F 11/34; G06Q 30/02; G06N 5/04; G06N 20/00

(52) U.S. Cl. CPC G06F 11/3442; G06Q 30/0206; G06N 5/04; G06N 20/00

(57) ABSTRACT

A system and method of financially managing cloud computing assets are disclosed. The method includes receiving operational parameters associated with cloud assets from cloud environment. The method includes computing real time overall operational efficiency of the cloud assets. Furthermore, the method includes determining a modification to be performed to the current operational values associated with each of the operational parameters. The method includes generating a recommended operational efficiency of the cloud assets based on the determined modification using a machine learning techniques. The method includes determining whether the recommended operational efficiency of the cloud assets require further optimization of the optimal operational values. Also, the method includes generating updated recommended operational efficiency of the cloud assets based on the determination. The method includes outputting the generated recommended operational efficiency of the cloud assets on a user interface.

### FIELD OF INVENTION

Embodiments of a present disclosure relate to cloud computing and more particularly to a system and a method for financial management of cloud computing assets.

### BACKGROUND

Cloud computing is one of the most revolutionary technological innovation of the 21st century. Cloud computing has seen the fastest adoption into the mainstream than any other technology in the domain. Adoption of cloud computing has been fuelled mainly by an ever-increasing number of devices that can access the communication network such as internet. Cloud computing is useful for organizations, and for an average person as well. The ever-increasing need of the organizations to transition to cloud computing requires rapid development of cloud computing assets capable of enabling cloud computing for the organizations. The cloud computing assets include cloud computing infrastructure and services such as platform as a service and software as a service. Such cloud computing assets are available on demand instead of a traditionally fixed capacity such as on-premises servers or software obtained by paying a fixed one-time fee. Such on demand capabilities are enabled through dedicated software for management of such on demand requirements of the organization.

Although, cloud computing is convenient and beneficial over the traditional on-premises servers and one-time payment software services, the on-demand capability of the cloud computing assets comes at a high cost compared to the traditional on-premises systems. Therefore, it is important for each organization to manage the costs associated with the cloud computing assets. Currently available cloud computing systems have limited cloud computing asset management capabilities and allow users to select and manage generic predefined parameters in the cloud computing assets. Such limited management capabilities of the cloud computing assets lead to wastage of assets and additional costs to the organizations.

Hence, there is a need for an improved system and a method for financial management of cloud computing assets to reduce costs in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a system for financial management of cloud assets is disclosed. The system includes one or more hardware processors and a memory coupled to the one or more hardware processors. The memory includes a plurality of subsystems in the form of programmable instructions executable by the one or more hardware processors. The plurality of subsystems includes an asset data receiver subsystem configured for receiving one or more operational parameters associated with one or more cloud assets from a cloud environment. The plurality of subsystem also includes an operational efficiency computing subsystem configured for computing a real time overall operational efficiency of the one or more cloud assets based on the received one or more operational parameters associated with the one or more cloud assets. Further, the plurality of subsystem includes a modification management subsystem configured for determining a modification to be performed to the one or more current operational values associated with each of the one or more operational parameters based on the computed real time overall operational efficiency. The one or more current operational values are determined to be modified to one or more optimal operational values. Further, the plurality of subsystem includes a recommendation subsystem configured for generating a recommended operational efficiency of the one or more cloud assets based on the determined modification using the one or more machine learning techniques. Further, the recommendation subsystem is configured for determining whether the recommended operational efficiency of the one or more cloud assets require further optimization of the one or more optimal operational values based on an input trigger. The input trigger is received from a user of the user device. The input trigger comprises one or more desired configuration of the one or more operational parameters. Furthermore, the recommendation subsystem is configured for generating an updated recommended operational efficiency of the one or more cloud assets based on the determination. Also, the plurality of subsystem includes an output subsystem configured for outputting the generated recommended operational efficiency of the one or more cloud assets on a user interface of the user device.

In accordance with another embodiment of the present disclosure, a method for financially managing cloud assets is disclosed. The method includes a receiving one or more operational parameters associated with one or more cloud assets from a cloud environment. Further, the method includes computing a real time overall operational efficiency of the one or more cloud assets based on the received one or more operational parameters associated with the one or more cloud assets. Furthermore, the method includes determining a modification to be performed to the one or more current operational values associated with each of the one or more operational parameters based on the computed real time overall operational efficiency. The one or more current operational values are determined to be modified to one or more optimal operational values. The method further includes generating a recommended operational efficiency of the one or more cloud assets based on the determined modification using the one or more machine learning techniques. The recommended operational efficiency comprises the one or more optimal operational values. The method further includes determining whether the recommended operational efficiency of the one or more cloud assets require further optimization of the one or more optimal operational values based on an input trigger, wherein the input trigger is received from a user of the user device, and wherein the input trigger comprises one or more desired configuration of the one or more operational parameters. Also, the method includes generating an updated recommended operational efficiency of the one or more cloud assets based on the determination. The method also includes outputting the generated recommended operational efficiency of the one or more cloud assets on a user interface of a user device.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary cloud computing environment for financial management of cloud computing assets in accordance with an embodiment of the present disclosure;

FIG. 2 is a block diagram illustrating an exemplary cloud computing system, such as those shown in FIG. 1, for financial management of the cloud computing assets in accordance with an embodiment of the present disclosure;

FIGS. 3A-G are snapshots of an exemplary graphical user interface configured for financially managing the cloud computing assets of FIG. 1 and FIG. 2 in accordance with an embodiment of the present disclosure; and

FIG. 4 is a process flow diagram illustrating an exemplary method for financially managing cloud computing assets in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

Embodiments of the present disclosure disclose a system and method for financial management of the cloud computing assets. The system includes a data collection subsystem operable by the one or more processors. The data collection subsystem is configured to collect operational data of one or more performance parameters of the cloud infrastructure for a predefined time interval. The system includes a data storage subsystem operable by the one or more processors. The data storage subsystem is configured to store the operational data of one or more performance parameters of the cloud infrastructure collected by the data collection subsystem in a database. The system includes an analysing subsystem operable by the one or more processors. The analysing subsystem is configured to analyse the operational data of the one or more performance parameters of the cloud infrastructure associated with the data stored by the data storage subsystem using one or more machine learning techniques to identify relationships between the one or more performance parameters and the relationships of the one or more performance parameters with one or more customer preferences respectively. The system includes a selection subsystem operable by the one or more processors. The selection subsystem is configured select one or more performance parameters analysed by the analysing subsystem based on an input received by the selection subsystem, wherein the input is representative of a selection of at least one of the one or more performance parameters. The system also includes a recommendation subsystem operable by the one or more processors. The recommendation subsystem is configured to generate one or more recommendations for altering a utilization of the cloud computing assets based on the at least one of the one or more performance parameters selected by the selection subsystem and the relationships identified by the one or more machine learning techniques.

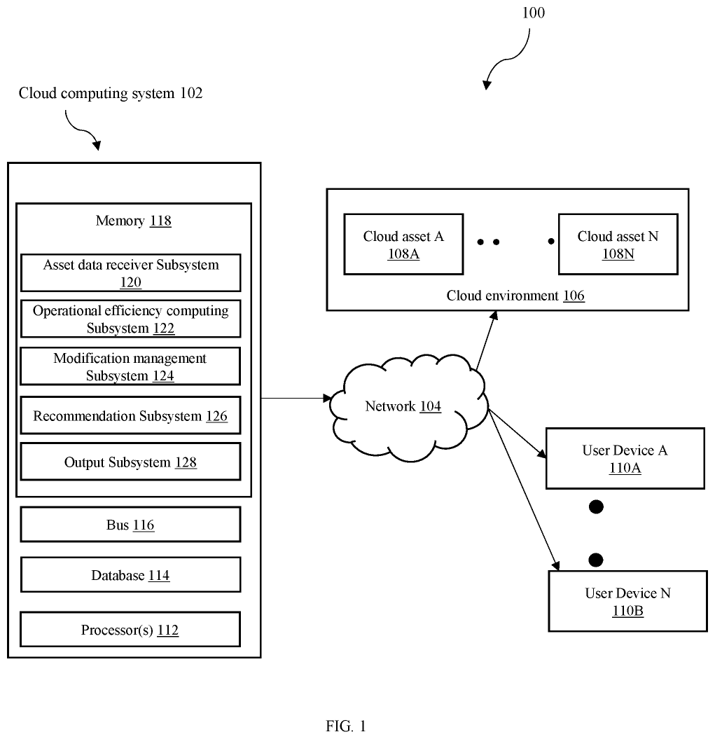

Referring now to the drawings, and more particularly to FIG. 1 through 4, where similar reference characters denote corresponding features consistently throughout the figures, there are shown preferred embodiments and these embodiments are described in the context of the following exemplary system and/or method.

FIG. 1 is a block diagram illustrating an exemplary cloud computing environment 100 for financial management of cloud computing assets 108A-N in accordance with an embodiment of the present disclosure. According to FIG. 1, the cloud computing environment 100 comprises a cloud computing system 102 which is capable of delivering cloud applications for managing a cloud environment 106 comprising cloud assets 108A-N. throughout the specification the term ‘cloud computing system’ may also be referred as ‘system’ and the ‘computing system’. The cloud computing system 102 is connected to the cloud assets 108A-N in the cloud environment 106 via a network 104 (e.g., Internet). The cloud computing system 102 is also connected to the one or more user devices 110A-N via the network 104. In one embodiment, the cloud assets 108A-N may include infrastructure as a service, platform as a service, and software as a service. In another embodiment, the infrastructure as a service may include a backup, a bandwidth, an express route, a key vault, a storage, one or more virtual machines, one or more virtual machine licenses, a virtual network, and a virtual private network gateway. In yet another embodiment, the platform as a service and software as a service may include an application gateway, an automation asset, one or more analysis services, one or more bot services, one or more blockchain services, an application service, a cognitive search service, a database service, a firewall service, a monitor, a protection service, site recovery service, one or more cognitive services. In one specific embodiment, the one or more communication networks may include, but not limited to, an internet connection, a wireless fidelity (WI-FI) and the like. Although, FIG. 1 illustrates the cloud computing system 102 connected to one cloud environment 106, one skilled in the art can envision that the cloud computing system 102 can be connected to several cloud environments located at different locations via the network 104.

The user devices 110A-N can be a laptop computer, desktop computer, tablet computer, smartphone and the like. The devices 110A-N can access cloud applications (such as providing performance visualization of the assets 108A-N) via a web browser.

The cloud computing system 102 includes a processor 112, a database 114, and a memory 118. The processor 112, and the memory 114, may be communicatively coupled by a system bus such as a system bus 116 or a similar mechanism. The cloud computing system 102 further includes a cloud interface, a server including hardware assets and an operating system (OS), a network interface, and application program interfaces (APIs). The cloud interface enables communication between the server and the cloud environment 106. Also, the cloud interface enables communication between the server and the user devices 110A-N. As used herein, “cloud computing environment” refers to a processing environment comprising configurable computing physical and logical assets, for example, networks, servers, storage, applications, services, etc., and data distributed over the cloud platform. The cloud computing environment 100 provides on-demand network access to a shared pool of the configurable computing physical and logical assets. The server may include one or more servers on which the OS is installed. The servers may comprise one or more processors, one or more storage devices, such as, memory units, for storing data and machine-readable instructions for example, applications and application programming interfaces (APIs), and other peripherals required for providing cloud computing functionality

The processor(s) 112, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 112 may also include embedded controllers, such as generic or programmable logic devices or arrays, application specific integrated circuits, single-chip computers, and the like.

The memory 118 may be non-transitory volatile memory and non-volatile memory. The memory 118 may be coupled for communication with the processor(s) 112, such as being a computer-readable storage medium. The processor(s) 112 may execute machine-readable instructions and/or source code stored in the memory 118. A variety of machine-readable instructions may be stored in and accessed from the memory 118. The memory 118 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 118 includes a plurality of subsystems stored in the form of machine-readable instructions on any of the above-mentioned storage media and may be in communication with and executed by the processor(s) 112.

The memory 118 includes a plurality of subsystems in the form of programmable instructions executable by the one or more hardware processors 112. The plurality of subsystems includes an asset data receiver subsystem 120 configured for receiving one or more operational parameters associated with one or more cloud assets 108A-N from a cloud environment 106. The one or more operational parameters comprises central processing unit (CPU), used memory, disk read or write per second, disk read byte or write byte per second, network byte received or sent per second, disk free space and the like. The plurality of subsystem also includes an operational efficiency computing subsystem 122 configured for computing a real time overall operational efficiency of the one or more cloud assets 108A-N based on the received one or more operational parameters associated with the one or more cloud assets 108A-N. The real time overall operational efficiency is a measure of current parameter performance level and cost performance level of the one or more cloud assets 108A-N. That is, the operational efficiency provides an indication whether the cloud assets 108A-n is underutilized, overutilized or neutrally utilized based on parameter performance and cost performance. Further, the plurality of subsystem includes a modification management subsystem 124 configured for determining a modification to be performed to the one or more current operational values associated with each of the one or more operational parameters based on the computed real time overall operational efficiency. The one or more current operational values are determined to be modified to one or more optimal operational values. The one or more operational values comprises name, device configuration, identifier, percentage usage, size, network consumption, location, date, instance identifier, and the like. Further, the plurality of subsystem includes a recommendation subsystem 126 configured for generating a recommended operational efficiency of the one or more cloud assets 108A-N based on the determined modification using the one or more machine learning techniques. The recommended operational efficiency comprises the one or more optimal operational values. The recommended operational efficiency provides an indication that if the operational values are modified to optimal operational values, the impact caused to the parameter performance and the cost performance. The recommendation operational efficiency provide for an improved utilization of the cloud assets 108A-N. Basically, the recommended operational efficiency provide one or more recommended settings with defined operational values for the operational parameters in order to work in a more efficient and cost-effective manner. Further, the recommendation subsystem 126 is configured for determining whether the recommended operational efficiency of the one or more cloud assets 108A-N require further optimization of the one or more optimal operational values based on an input trigger. The input trigger is received from a user of the user device 110A-N. The input trigger comprises one or more desired configuration of the one or more operational parameters. The desired configuration comprises one or more desired (or intended) operational values of the one or more operational parameters. Furthermore, the recommendation subsystem 126 is configured for generating an updated recommended operational efficiency of the one or more cloud assets 108A-N based on the determination. Th updated recommended operational efficiency provides an updated recommended setting of the one or more operational parameters. Also, the plurality of subsystem includes an output subsystem 128 configured for outputting the generated recommended operational efficiency of the one or more cloud assets 108A-N on a user interface of the user device 110A-N.

The cloud database 114 stores the information relating to the cloud environment 106 and the user device (s) 110A-N. The cloud database 114 is, for example, a structured query language (SQL) data store. The cloud database 114 is configured as cloud-based database implemented in the cloud computing environment 100, where computing assets are delivered as a service over a cloud platform. The cloud database 114, according to another embodiment of the present disclosure, is a location on a file system directly accessible by the plurality of subsystems. The database 114 is configured to store asset information, asset parameters, error logs, performance data, pricing models, user rating and the like.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of a cloud computing system 102 as is unique to the present disclosure or necessary for an understanding of the present disclosure is depicted and described. The remainder of the construction and operation of the cloud computing system 102 may conform to any of the various current implementation and practices known in the art.

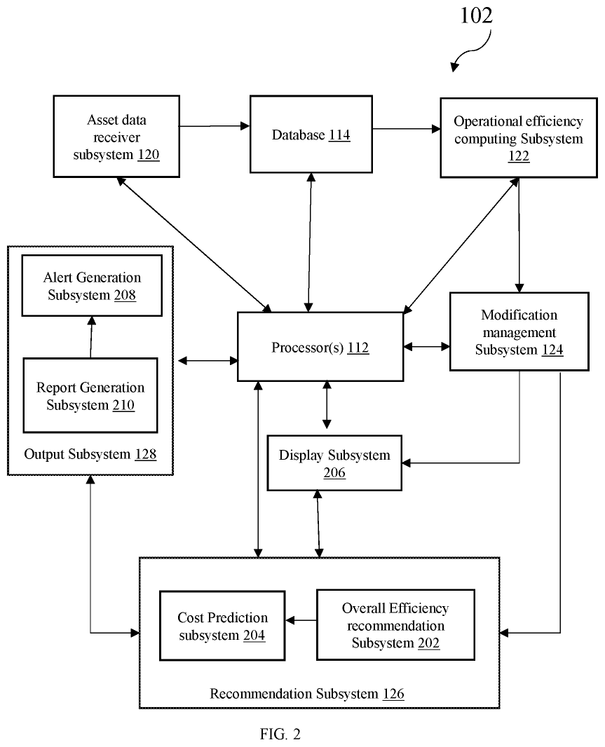

FIG. 2 is a block diagram illustrating an exemplary cloud computing system 102, such as those shown in FIG. 1, for financial management of the cloud computing assets 108A-N in accordance with an embodiment of the present disclosure. In FIG. 2, the cloud computing system 102 comprises a plurality of subsystems which includes asset data receiver subsystem 120, a database 114, an operational efficiency computing subsystem 122, a modification management subsystem 124, a recommendation subsystem 126, an output subsystem 128, a processor 112 and a display subsystem 206.

The processor 112 and the database 114 are similar to those shown in FIG. 1. Hence, the description of such processor 112 and the database 114 are same as described above in FIG. 1.

The asset data receiver subsystem 120 is configured to receive one or more operational parameters associated with one or more cloud assets 108A-N from the cloud environment 106. The asset data receiver subsystem 120 is also configured to receive other relative information associated with the one or more cloud assets 108A-N from the cloud environment 106. The other relative information includes tenant information, subscription information, asset group information, location information, tag information and the like. In one embodiment, the asset data receiver subsystem 120 may receive the operational parameters and the other relative information of the one or more cloud computing assets after a pre-defined interval of time. In one exemplary embodiment, the asset data receiver subsystem 120 may receive the operational parameters and the other relative information of the one or more cloud computing assets every minute. The received data is then fed to the database 114.

The operational efficiency computing subsystem 122 is configured for computing a real time overall operational efficiency of the one or more cloud assets 108A-N based on the received one or more operational parameters associated with the one or more cloud assets 108A-N. In order to compute the real time overall operational efficiency, the operational efficiency computing subsystem 122 is configured for analysing the received one or more operational parameters associated with the one or more cloud assets 108A-N using one or more machine learning techniques. The one or more machine learning techniques comprises boosted regression decision algorithm. The operational efficiency computing subsystem 122 uses the one or more machine learning techniques to determine a relationship between the one or more performance parameters of the one or more cloud computing assets 108A-N and also determines a relationship between the one or more performance parameters of the one or more cloud computing assets 108A-N and one or more customer preferences, respectively. Upon analysing the one or more operational parameters, the operational efficiency computing subsystem 122 is configured for determining last recorded maximum operational value associated with each of the received one or more operational parameters based on the analysis. The last recorded maximum operational value is the highest operational value of the operational parameter, for example, if a virtual machine (VM) has a CPU utilization of 15% which is the last recorded maximum value. Upon determining this last recorded maximum operational value of the operational parameter, the operational efficiency computing subsystem 122 is configured for computing the real time overall operational efficiency of the one or more cloud assets 108A-N based on the determined last recorded maximum operational value associated with each of the received one or more operational parameters. This computed real time overall operational efficiency is then fed to the modification management subsystem 124.

In order to determine the last recorded maximum operational value associated with each of the received one or more operational parameters, the operational efficiency computing subsystem 122 is configured for computing one or more types of aggregation values for the received one or more operational parameters. The one or more types of aggregation values comprises last recorded hundred percentile operational value, average operational value, last recorded maximum operational value, and last recorded eightieth percentile operational value. For example, initially, four different types of aggregations, i.e., Maximum, Average, 90th and 80th percentile are first calculated. The 90th percentile is calculated using the “percentile” function available in the Kusto-query language (Language used to query the data from log analytics workspace, the monitoring solution provided by Azure). In an embodiment, the user is provided an option to choose various types of aggregations, i.e., either Maximum, Average, 90th and 80th percentile. For example, for a VM, if the CPU hits 100% utilization once a month just for a few seconds, it would still be considered as the peaking point if “Max” is the type of aggregation that is selected by the user. However, this may not be the best way to understand the performance of an asset. Hence, choosing 90th or 80th percentile calculated is recommended as they provide a more accurate representation of the current utilization for any asset. Once the one or more types of aggregation values is computed, the operational efficiency computing subsystem 122 is further configured for classifying the computed one or more types of the aggregation values based on the type of the one or more operational parameter. The one or more types of aggregation values are classified into mis-provisioned, unused, overused assets. In case of unused or underutilized assets, for example, if a VM has zero CPU utilization every day during a particular period of time, this means that it is not being utilized at that point of time. Such consumption pattern of the operational parameter is identified, and an insight is provided to the end user. In case of mis-provisioned asset, for example, if a VM has a CPU utilization of 15%, RAM and IOPS utilization also less than 10% in the last 30 days and it has a maximum capability of 32 core CPU, 224 GB RAM and 51200 IOPS, this means that the operational parameters are not rightly provisioned. In such cases, the operational parameter is denoted as mis provisioned asset to the user and a suitable recommendation of a substantially lower size (lower CPU, Memory, IOPS capability) may be generated.

Once the one or more type of aggregation values are classified in the above manner, the operational efficiency computing subsystem 122 is configured for determining the respective last recorded maximum operational value associated with each of the one or more operational parameters based on the classified one or more types of aggregation values.

The modification management subsystem 124 is configured for determining a modification to be performed to the one or more current operational values associated with each of the one or more operational parameters based on the computed real time overall operational efficiency. The one or more current operational values are determined to be modified to one or more optimal operational values. The modification may include upgrading, degrading, replacing, adding or deleting an operational value or even an operational parameter. The optimal operational values are the modified values or transformed values of the one or more current operational values. In an embodiment, in determining the modification to be performed, the modification management subsystem 124 is configured for identifying the type of operational parameter associated with the one or more cloud assets 108A-N based on the received one or more operational parameters. The type of operational parameter includes configuration type, mapped cloud asset type, family type or series type and the like. Further, the medication management subsystem 124 is configured for determining one or more relative parameters associated with the determined type of operational parameters based on other cloud asset information received from the cloud environment. The one or more relative parameters includes, but not limited to cost savings, location, tag information, tenant information, subscription information and the like. Further, the modification management subsystem 124 is configured for determining maximum operational capacity value of the identified type of operational parameter based on the determined one or more relative parameters and based on a prestored cloud asset library. The prestored cloud asset library comprises historical asset information of all cloud assets 108A-N. The asset information may include past operational values, past operational parameters, past recommended operational efficiency, past user details, past connection details, past asset configuration details and the like. The maximum operational capacity is a measure of highest operating range that an asset can reach. The modification management subsystem 124 is configured for comparing the current operational value of the one or more operational parameters with the determined maximum operational capacity value of the identified type of operational parameter. Further, the modification management subsystem 124 is configured for determining best suitable range of operational value of the one or more operational parameters based on the comparison and by using a machine learning based asset model. For example, if a VM has 20 core, 100 GB RAM, 10000 IOPS and if the current operational efficiency is less than 10%, then a VM template or size with a maximum capability of 2 core, 10 GB RAM, 1000 IOPS is determined as best suitable range of operational value that is more than enough to handle this workload. However, it is to be noted that if the VM template is resized to a 2 core, 10 GB RAM machine, then the operational efficiency would shoot up to 100%, which is not ideal. Hence, the modification management subsystem 124 intelligently determines a best suitable size for resizing that keeps the target utilization (The operational efficiency that would be achieved if the recommended resizing is implemented) in the range between 35%-80%. Hence, this step of determination of best suitable range of operational value is important further for recommendation subsystem 126. The modification management subsystem 124 is further configured for determining type of modification to be performed to the current operational value of the one or more operational parameters based on the determined best suitable range of the operational value. The type of modification comprises changing size, mode, frequency and allocation of assets associated with the one or more operational parameters. Once, best suitable range of operating value is determined, it is determined whether the current operational value needs to be upgraded to a new value or degraded to a lower value or needs to be kept at idle mode or needs a complete replacement and so on.

The recommendation subsystem 126 comprises of an overall efficiency recommendation subsystem 202 and a cost prediction subsystem 204. The overall efficiency recommendation subsystem 202 is configured for generating a recommended operational efficiency of the one or more cloud assets 108A-N based on the determined modification using the one or more machine learning techniques. The recommended operational efficiency comprises the one or more optimal operational values.

In order to generate the recommended operational efficiency, the cost prediction subsystem 204 is configured for determining a cost estimate model for the modified operational values of the one or more operational parameters based on a suitable machine learning model. In one embodiment, the cost prediction subsystem 204 may predict the cost incurred by the user after the pre-defined interval of time. In another embodiment, the one or more users may define the interval of time. In an exemplary embodiment, the cost associated with the one or more users may be predicted every month. In another embodiment, the cost prediction subsystem 204 may use the predicted cost to train the machine learning model for future predictions of cost. The cost prediction subsystem 204 uses a cost prediction model built in Azure ML studio, that trains on the trailing six months or one year of the cost data. The cost data is categorized across various services and differentiated as Infrastructure, Platform, Software as a service. The number of assets per service and their associated cost is retrieved from the database 114. The cost data for the services such as backup, bandwidth, VM's and the like are obtained using a billing API. The hourly billing data obtained is then cumulated and restructured for easier analysis in the front end. This amount to the cost data. Then, cost distribution across various business units on a day-to-day basis is calculated based on the current tagging methodology. Users can analyse the services within each business units and their daily cost variations. Similarly, they can drill down to subservices and individual components within that particular service. Based on this data, the cost estimate model depicting a cost trend for the all the services within a business unit is determined for the selected date range along with a notification of any new asset added.

Then, the cost prediction subsystem 204 predicts the expected cost for the current month on a day-to-day basis. For a steady state environment, the model is extremely prudent and has an accuracy rate of 96.4%. In an exemplary embodiment, a binary regression decision tree algorithm may be used for determining cost estimate model. The cost estimate model represents correlation between cost performance parameters with respect to time. The cost performance parameters may be expenditures, loses, savings and impacts and the like.

Further, in one embodiment, the cost prediction subsystem 204 may analyse a growth associated with the one or more users to predict a future cost of the one or more cloud computing assets 108A-N associated with the one or more new users. The cost prediction subsystem 204 primarily uses date and time of the year to predict the future cost. Hence, any weekly or monthly patterns are predicted along with seasonal spikes. For example, the spike in cost associated with the VM's hosting online shopping websites during holiday season's every year and such.

Further, in one embodiment, the cost prediction subsystem 204 may also enable the one or more users to minimize the cost of the one or more cloud computing assets 108A-N in accordance with the predicted costs. In one embodiment, the cost prediction subsystem 204 may provide one or more methods to the one or more users to minimize the costs. In such embodiments, the one or more methods may include, but not limited to, a method for saving on the cost, a method to reduce the usage of the cloud infrastructure and the like. In one embodiment, the one or more users may approve at least one of the one or more methods provided by the cost prediction subsystem 204. In one embodiment, the cost prediction subsystem 204 may suggest the one or more users to re-allocate the cost based on a usage of the one or more cloud computing assets and the cost predicted by the cost prediction subsystem 204.

The overall efficiency recommendation subsystem 202 further collects the cost estimated model as an input from the cost prediction subsystem 204 and is further configured for inferring a relationship between each of the modified operational values of the one or more operational parameters. For example, relationships between CPU, memory, disk vales and the like. Further, the overall efficiency recommendation subsystem 202 is configured for determining an overall performance score for each of the one or more operational parameters based on the determined cost estimate model and the inferred relationship. The overall performance score indicates the parameter performance level and the cost performance level of the one or more operational parameters. For example, the overall performance score indicates low, high or neutral performance levels of parameter and the cost. Further, the operational efficiency recommendation subsystem 202 is configured for generating the recommended operational efficiency of the one or more cloud assets 108A-N based on the determined overall performance score. The generated recommended operational efficiency includes one or more recommendations for altering a utilization of the cloud computing assets 108A-N based on the at least one of the one or more performance parameters and the relationships inferred. In an embodiment, the one or more recommendations may be recommending the user to classify the data and distribute the data of different classifications under different storage services to minimize cost. In one specific embodiment, the recommendation subsystem 126 may recommend a type of disk attachment to the system for the one or more users based on an environment and requirement associated with the one or more users. In such embodiment, the type of disk may include, but not limited to, a premium disk, a standard disk and the like. For example, in case of a VM (AZRAUEUIS9501) which is of the size “Standarad_E32-16s_v3”, the current CPU, memory and IOPS percentage is very low, in this case the recommendation subsystem 126 generates a recommendation of a lower size or template (Standard_E2s_v3) to improve the utilization of VM's operational parameters. The initial recommendation (to move to “Standard_E2s_v3”) is generated by considering the current “series” of the VM (E-series in this case).

Further, the overall efficiency recommendation subsystem 202 is configured for determining whether the recommended operational efficiency of the one or more cloud assets 108A-N require further optimization of the one or more optimal operational values based on an input trigger. The input trigger is received from a user of the user device 110A-N. The input trigger comprises one or more desired configuration of the one or more operational parameters. For this determination, the the overall efficiency recommendation subsystem 202 is configured for parsing the input trigger received from the user of the user device 110A-N to extract the one or more desired configuration of the one or more operational parameters and determining whether the one or more operational values require a modification by comparing the one or more optimal operational values with that of the one or more desired configuration. In an embodiment, the overall efficiency recommendation subsystem 202 provides users an option to choose ‘customized’ recommendation settings based on the generated first recommended operational efficiency. With this option, the users may prioritize the at least one of the one or more performance parameters to customize based on customer preferences. In an embodiment, a user may select at least one of the one or more recommendations generated by the recommendation subsystem 126. In another embodiment, the user may update the at least one of the one or more performance parameters to generate one or more new recommendations. In one embodiment, the one or more users may apply one or more filters for generating the one or more recommendations. In such embodiment, the one or more filters may include, but not limited to, a location of the system and the like. In one embodiment, the one or more users may approve the one or more recommendations generated by the recommendation subsystem 126. In another embodiment, the one or more users may decline the one or more recommendations generated by the recommendation subsystem 126.

The overall efficiency recommendation subsystem 202 is further configured for generating an updated recommended operational efficiency of the one or more cloud assets 108A-N based on the determination. In an embodiment, if the user has provided his desired configurations for the operational parameters, and if these configurations are different from the recommended optimal operational values, then the overall efficiency recommendation subsystem 202 further generates a second recommendation covering the desired configurations provided by the user. In order to generate such updated recommended operational efficiency, the overall efficiency recommendation subsystem 202 is further configured for modifying the one or more operational parameters and the corresponding optimal operational values based on the desired configuration. Further, the overall efficiency recommendation subsystem 202 is configured for determining an updated cost estimate model for the modified optimal operational values of the modified one or more operational parameters based on a suitable machine learning model. A binary regression decision tree machine learning model may be used here. Further, the the overall efficiency recommendation subsystem 202 is configured for inferring a relationship between each of the modified optimal operational values of the modified one or more operational parameters. Further, the overall efficiency recommendation subsystem 202 is configured for determining an updated overall performance score for each of the modified one or more operational parameters based on the determined updated cost estimate model and the inferred relationship. The updated overall performance score indicates the modified parameter performance level and the modified cost performance level of the modified one or more operational parameters. Also, the overall efficiency recommendation subsystem 202 is configured for generating the updated recommended operational efficiency of the one or more cloud assets 108A-N based on the determined updated overall performance score.

The recommendation subsystem 126 is further configured for predicting future operational efficiency of the one or more cloud-based assets 108A-N based on the generated recommended operational efficiency and the updated recommended operational efficiency using a suitable machine learning based model. The future operational efficiency comprises parameter future performance level and cost future performance level.

The output subsystem 128 is configured for outputting the generated recommended operational efficiency of the one or more cloud assets 108A-N on the user interface of the user device 110A-N. The output subsystem 128 comprises an alert generation subsystem 208 and a report generation subsystem 210. In outputting the generated recommended operational efficiency, the output subsystem 128 is configured for generating one or more visualizations for the recommended operational efficiency and displaying the generated one or more visualizations on the user interface of the user device 110A-N.

The alert generation subsystem 208 operable by the one or more processors 112. The alert generation subsystem 208 generates one or more alerts about one or more updates for the one or more users. In one embodiment, the one or more updates may include, but not limited to, a subscription update, a consumption update, a performance update and the like. In one embodiment, the alert generation subsystem 208 may monitor the one or more cloud computing assets 108A-N to receive the one or more updates.

Further, the report generation subsystem 210 is operable by the one or more processors 112 The report generation subsystem 210 generates one or more reports associated with the one or more details displayed by the display subsystem 206. In one embodiment, the report generation subsystem 210 may generate the one or more performance and cost reports for a pre-defined interval of time. Further, the reports may be the cloud inventory report, cost distribution across business units-based report, cloud services report and performance utilization report. Further, these reports generated including a consumption pattern are used by the overall efficiency recommendation subsystem 202 to generate recommended operational efficiency.

Further, the display subsystem 206 is operable by the one or more processors 112. The display subsystem 206 displays one or more details associated with the one or more cloud computing assets 108A-N used by the one or more users. In such embodiment, the one or more details may include, but not limited to, a type of cloud asset, the cost predicted, expense associated with the one or more cloud computing assets 108A-N, highest cost consuming cloud asset 108A-N, one or more new assets added to the environment 106 and the like. In one embodiment, the display subsystem 206 may display the one or more details in a form of one or more graphs. In such embodiment, the one or more graphs may include, a bar graph, a pie chart, a histogram and the like. In one specific embodiment, the display subsystem 206 may include a user interface to display the one or more details.

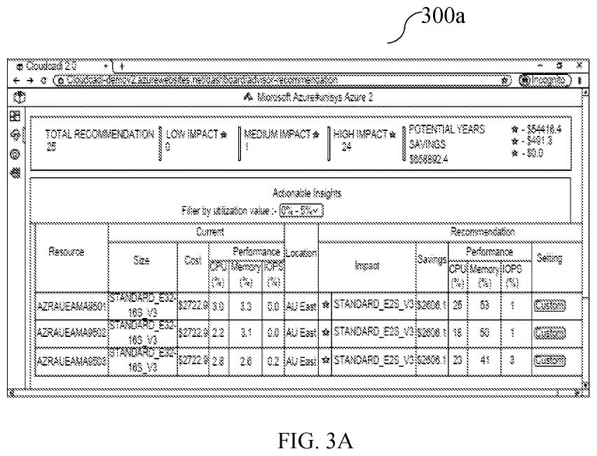

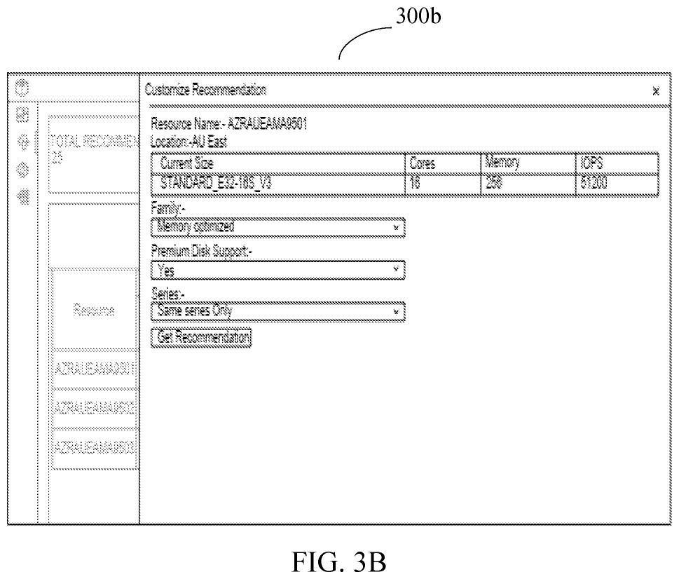

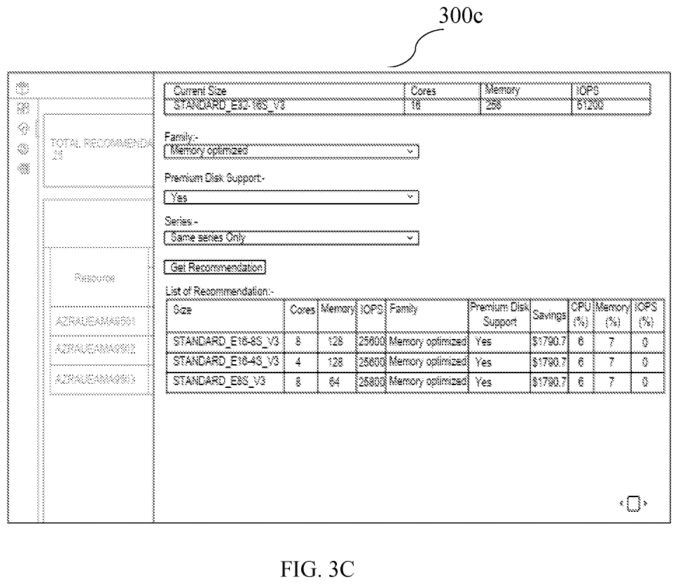

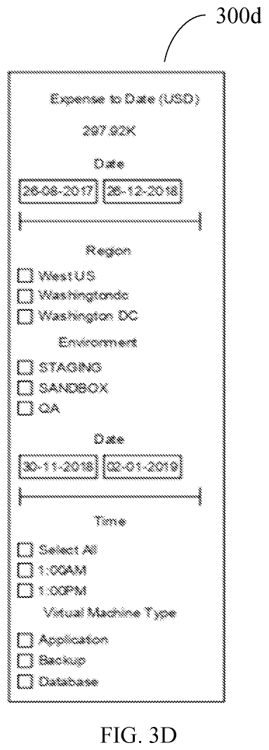

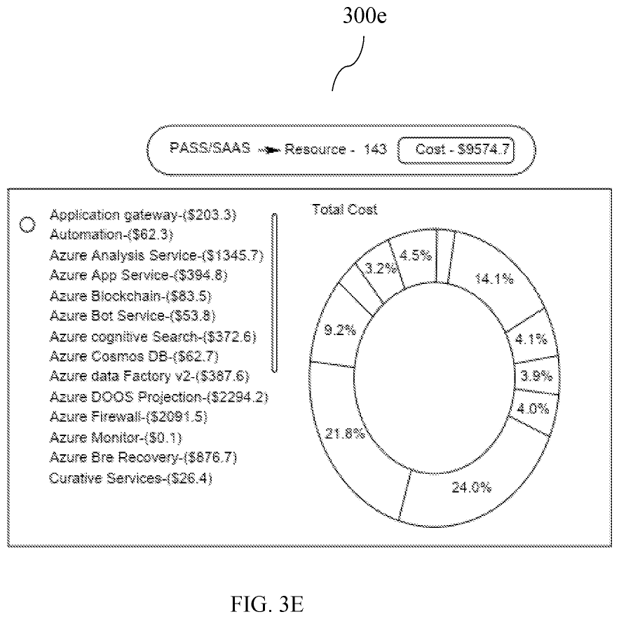

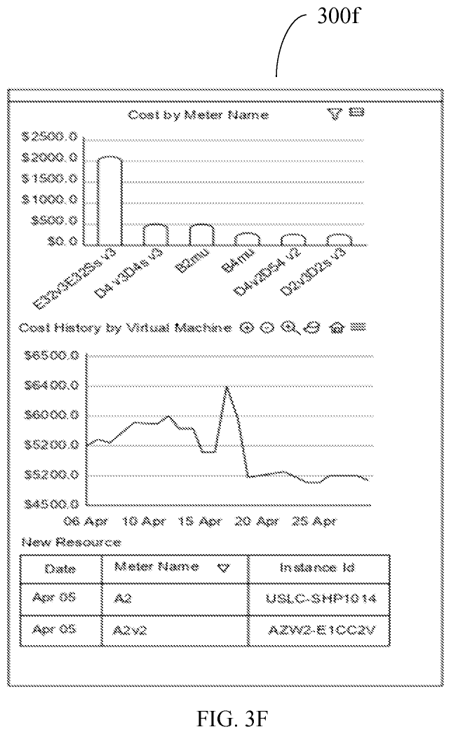

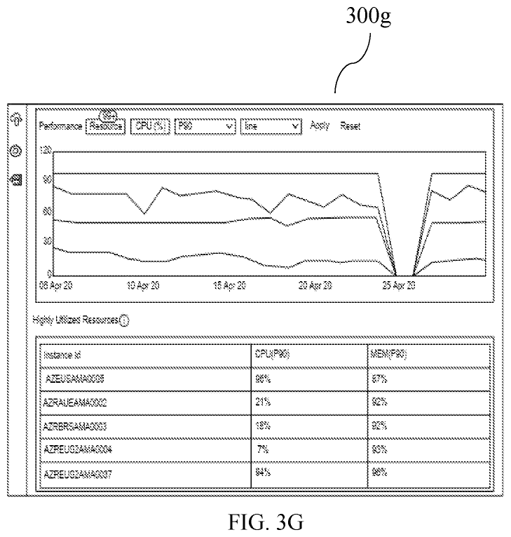

FIGS. 3A-G are snapshots of an exemplary graphical user interface configured for financially managing the cloud computing assets of FIG. 1 and FIG. 2 in accordance with an embodiment of the present disclosure. FIG. 3A is an exemplary graphical user interface depicting list of recommendations generated for list of cloud assets 108A-N, along with the operational parameters such as CPU, memory, IOPS, size, cost, and the like. The FIG. 3A also depicts the mapping of other related parameters such as location, to the operational parameters of each cloud assets 108A-N. For each cloud asset (also referred as resource), respective current operational parameters, location, impact is generated. Further, for each such asset, a suitable operational efficiency is recommended with optimal values of the operational parameters. In case the user requires a further customization of such recommended operational efficiency, a ‘customize’ option is provided to him. FIG. 3B depicts the options provided to the user when he selects the ‘customize’ option. Under the customize option, various other parameters such as family, premium disk supported, and series are provided to the user. These are the desired configurations of the user. Once these details are inputted by the user, the system 102 automatically generates an updated recommendation. FIG. 3C depicts the variety of options of resizing, provided to the user upon selecting the ‘get recommendation button’, along with their maximum capability, potential monthly savings and target utilization if resized. FIG. 3D-3G depicts one or more reports or graphs generated. FIG. 3D depicts a cost distribution report, FIG. 3E depicts an asset utilization report per business unit, FIG. 3F depicts cost distribution per asset, FIG. 3G depicts performance utilization report with respect to a time range.

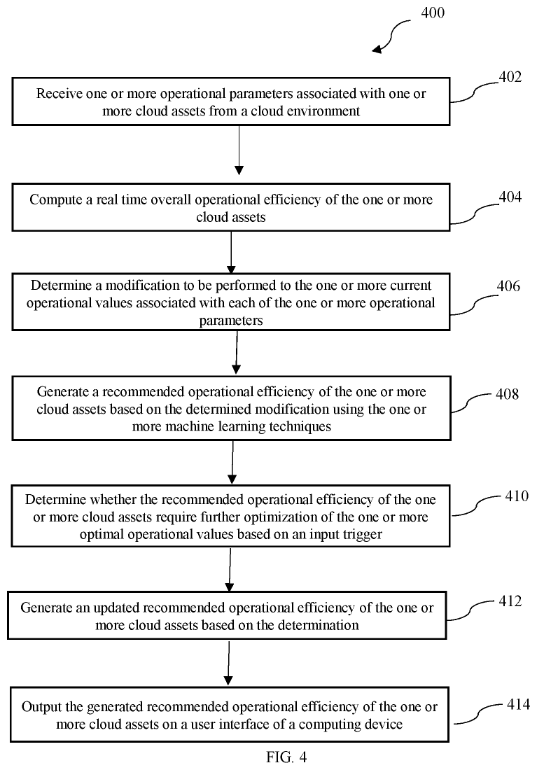

FIG. 4 is a process flow diagram illustrating an exemplary method 400 for financially managing cloud computing assets 108A-N in accordance with an embodiment of the present disclosure. At step 402, one or more operational parameters associated with one or more cloud assets 108A-N is received from a cloud environment 106. At step 404, a real time overall operational efficiency of the one or more cloud assets 108A-N is computed based on the received one or more operational parameters associated with the one or more cloud assets 108A-N. At step 406, a modification to be performed to the one or more current operational values associated with each of the one or more operational parameters is determined based on the computed real time overall operational efficiency. The one or more current operational values are determined to be modified to one or more optimal operational values. At step 408, a recommended operational efficiency of the one or more cloud assets 108A-N is generated based on the determined modification using the one or more machine learning techniques. The recommended operational efficiency comprises the one or more optimal operational values. At step 410, it is determined whether the recommended operational efficiency of the one or more cloud assets require further optimization of the one or more optimal operational values based on an input trigger. The input trigger is received from a user of the user device 110A-N and the input trigger comprises one or more desired configuration of the one or more operational parameters. At step 412, an updated recommended operational efficiency of the one or more 108A-N s 108A-N is generated based on the determination. At step 414, the generated recommended operational efficiency of the one or more cloud assets 108A-N is outputted on a user interface of a user device 110A-N

Further, the method 400 in computing the real time overall operational efficiency of the one or more cloud assets 108A-N based on the received one or more operational parameters associated with the one or more cloud assets 108A-N includes analysing the received one or more operational parameters associated with the one or more cloud assets 108A-N using one or more machine learning techniques. Further, the method includes determining last recorded maximum operational value associated with each of the received one or more operational parameters based on the analysis. Also, the method includes computing the real time overall operational efficiency of the one or more cloud assets 108A-N based on the determined last recorded maximum operational value associated with each of the received one or more operational parameters.

Further, in determining last recorded maximum operational value associated with each of the received one or more operational parameters based on the analysis, the method 400 includes computing one or more types of aggregation values for the received one or more operational parameters, wherein the one or more types of aggregation values comprises last recorded hundred percentile operational value, average operational value, last recorded maximum operational value, and last recorded eightieth percentile operational value. Further, the method 400 includes classifying the computed one or more types of the aggregation values based on the type of the one or more operational parameter. Further, the method 400 includes determining the respective last recorded maximum operational value associated with each of the one or more operational parameters based on the classified one or more types of aggregation values.

Furthermore, in determining the modification to be performed to the one or more current operational values associated with each of the one or more operational parameters based on the computed real time overall operational efficiency, the method 400 includes identifying the type of operational parameter associated with the one or more cloud assets 108A-N based on the received one or more operational parameters. Further, the method 400 includes determining one or more relative parameters associated with the determined type of operational parameters based on other cloud asset information received from the cloud environment. Further, the method 400 includes determining maximum operational capacity value of the identified type of operational parameter based on the determined one or more relative parameters and based on a prestored cloud asset library. Further, the method 400 include comparing the current operational value of the one or more operational parameters with the determined maximum operational capacity value of the identified type of operational parameter. Furthermore, the method 400 includes determining best suitable range of operational value of the one or more operational parameters based on the comparison and by using a machine learning based asset model. Further, the method 400 includes determining type of modification to be performed to the current operational value of the one or more operational parameters based on the determined best suitable range of the operational value, wherein the type of modification comprises changing size, mode, frequency and allocation of assets associated with the one or more operational parameters.

Additionally, in generating the recommended operational efficiency of the one or more cloud assets 108A-N based on the determined modification using the one or more machine learning techniques, the method includes determining a cost estimate model for the modified operational values of the one or more operational parameters based on a suitable machine learning model. Further, the method 400 includes inferring a relationship between each of the modified operational values of the one or more operational parameters. Furthermore, the method 400 includes determining an overall performance score for each of the one or more operational parameters based on the determined cost estimate model and the inferred relationship, wherein the overall performance score indicates the parameter performance level and the cost performance level of the one or more operational parameters. Further, the method 400 incudes generating the recommended operational efficiency of the one or more cloud assets 108A-N based on the determined overall performance score.

In determining whether the recommended operational efficiency of the one or more cloud assets 108A-N require further optimization of the one or more optimal operational values based on an input trigger, the method includes parsing the input trigger received from the user of the user device to extract the one or more desired configuration of the one or more operational parameters. Further, the method includes determining whether the one or more operational values require a modification by comparing the one or more optimal operational values with that of the one or more desired configuration.

In generating the updated recommended operational efficiency of the one or more cloud assets 108A-N based on the determination, the method 400 includes modifying the one or more operational parameters and the corresponding optimal operational values based on the desired configuration. The method further includes determining an updated cost estimate model for the modified optimal operational values of the modified one or more operational parameters based on a suitable machine learning model. The method 400 includes inferring a relationship between each of the modified optimal operational values of the modified one or more operational parameters. The method 400 includes determining an updated overall performance score for each of the modified one or more operational parameters based on the determined updated cost estimate model and the inferred relationship, wherein the updated overall performance score indicates the modified parameter performance level and the modified cost performance level of the modified one or more operational parameters. Further, the method 400 includes generating the updated recommended operational efficiency of the one or more cloud assets 108A-N based on the determined updated overall performance score.

In outputting the generated recommended operational efficiency of the one or more cloud assets 108A-N on the user interface of the user device 110A-N, the method 400 includes generating one or more visualizations for the recommended operational efficiency; and displaying the generated one or more visualizations on the user interface of the user device 110A-N.

Furthermore, the method 400 includes predicting future operational efficiency of the one or more cloud-based assets based on the generated recommended operational efficiency and the updated recommended operational efficiency using a suitable machine learning based model, wherein the future operational efficiency comprises parameter future performance level and cost future performance level.

Various embodiments of the present system provide a technical solution to the problem of optimizing cloud infrastructure. The present system provides an automates system for continuous improvements and immediate cost savings by using multiple machine learning models for analysing and predicting the cost. Further, the present system provides a customizable system for catering various needs of the one or more users, which makes the system user-friendly. Moreover, the current system uses various machine learning algorithms for cost prediction and cost optimization which helps in avoiding cost escalation and eliminate unused asset deployments. Also, the current disclosure retrieves the data at constant intervals, which decreases the amount of redundant data.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

1. A cloud computing system for financially managing cloud resources in a cloud computing environment, the system comprising:
one or more hardware processors; and
a memory coupled to the one or more hardware processors, wherein the memory comprises a plurality of subsystems in the form of programmable instructions executable by the one or more hardware processors, wherein the plurality of subsystem comprises:
an asset data receiver subsystem configured for receiving one or more operational parameters associated with one or more cloud assets from a cloud environment;
an operational efficiency computing subsystem configured for computing a real time overall operational efficiency of the one or more cloud assets based on the received one or more operational parameters associated with the one or more cloud assets;
a modification management subsystem configured for determining a modification to be performed to the one or more current operational values associated with each of the one or more operational parameters based on the computed real time overall operational efficiency, wherein the one or more current operational values are determined to be modified to one or more optimal operational values;
a recommendation subsystem configured for:
generating a recommended operational efficiency of the one or more cloud assets based on the determined modification using the one or more machine learning techniques, wherein the recommended operational efficiency comprises the one or more optimal operational values;
determining whether the recommended operational efficiency of the one or more cloud assets require further optimization of the one or more optimal operational values based on an input trigger, wherein the input trigger is received from a user of the user device, and wherein the input trigger comprises one or more desired configuration of the one or more operational parameters; and
generating an updated recommended operational efficiency of the one or more cloud assets based on the determination; and
an output subsystem configured for outputting the generated recommended operational efficiency of the one or more cloud assets on a user interface of a user device.

2. The system of claim 1, wherein in computing the real time overall operational efficiency of the one or more cloud assets based on the received one or more operational parameters associated with the one or more cloud assets, the operational efficiency computing subsystem is configured for:
analyzing the received one or more operational parameters associated with the one or more cloud assets using one or more machine learning techniques;
determining last recorded maximum operational value associated with each of the received one or more operational parameters based on the analysis; and
computing the real time overall operational efficiency of the one or more cloud assets based on the determined last recorded maximum operational value associated with each of the received one or more operational parameters.

3. The system of claim 2, wherein in determining last recorded maximum operational value associated with each of the received one or more operational parameters based on the analysis, the operational efficiency computing subsystem is configured for:
computing one or more types of aggregation values for the received one or more operational parameters, wherein the one or more types of aggregation values comprises last recorded hundred percentile operational value, average operational value, last recorded maximum operational value, and last recorded eightieth percentile operational value;
classifying the computed one or more types of the aggregation values based on the type of the one or more operational parameter; and
determining the respective last recorded maximum operational value associated with each of the one or more operational parameters based on the classified one or more types of aggregation values.

4. The system of claim 1, wherein in determining the modification to be performed to the one or more current operational values associated with each of the one or more operational parameters based on the computed real time overall operational efficiency, the modification management subsystem is configured for:
identifying the type of operational parameter associated with the one or more cloud assets based on the received one or more operational parameters;
determining one or more relative parameters associated with the determined type of operational parameters based on other cloud asset information received from the cloud environment;
determining maximum operational capacity value of the identified type of operational parameter based on the determined one or more relative parameters and based on a prestored cloud asset library;
comparing the current operational value of the one or more operational parameters with the determined maximum operational capacity value of the identified type of operational parameter;
determining best suitable range of operational value of the one or more operational parameters based on the comparison and by using a machine learning based asset model;
determining type of modification to be performed to the current operational value of the one or more operational parameters based on the determined best suitable range of the operational value, wherein the type of modification comprises changing size, mode, frequency and allocation of resources associated with the one or more operational parameters.

5. The system of claim 1, wherein in generating the recommended operational efficiency of the one or more cloud assets based on the determined modification using the one or more machine learning techniques, the recommendation subsystem is configured for:
determining a cost estimate model for the modified operational values of the one or more operational parameters based on a suitable machine learning model;
inferring a relationship between each of the modified operational values of the one or more operational parameters;
determining an overall performance score for each of the one or more operational parameters based on the determined cost estimate model and the inferred relationship, wherein the overall performance score indicates the parameter performance level and the cost performance level of the one or more operational parameters; and
generating the recommended operational efficiency of the one or more cloud assets based on the determined overall performance score.

6. The system of claim 1, wherein in determining whether the recommended operational efficiency of the one or more cloud assets require further optimization of the one or more optimal operational values based on an input trigger, the recommendation subsystem is configured for:
parsing the input trigger received from the user of the user device to extract the one or more desired configuration of the one or more operational parameters; and
determining whether the one or more operational values require a modification by comparing the one or more optimal operational values with that of the one or more desired configuration.

7. The system of claim 1, wherein in generating the updated recommended operational efficiency of the one or more cloud assets based on the determination, the recommendation subsystem is configured for:
modifying the one or more operational parameters and the corresponding optimal operational values based on the desired configuration;
determining an updated cost estimate model for the modified optimal operational values of the modified one or more operational parameters based on a suitable machine learning model;
inferring a relationship between each of the modified optimal operational values of the modified one or more operational parameters;
determining an updated overall performance score for each of the modified one or more operational parameters based on the determined updated cost estimate model and the inferred relationship, wherein the updated overall performance score indicates the modified parameter performance level and the modified cost performance level of the modified one or more operational parameters; and
generating the updated recommended operational efficiency of the one or more cloud assets based on the determined updated overall performance score.

8. The system of claim 1, wherein in outputting the generated recommended operational efficiency of the one or more cloud assets on the user interface of the user device, the output subsystem is configured for:
generating one or more visualizations for the recommended operational efficiency; and
displaying the generated one or more visualizations on the user interface of the user device.

9. The system of claim 1, wherein the recommendation subsystem is further configured for:
predicting future operational efficiency of the one or more cloud based assets based on the generated recommended operational efficiency and the updated recommended operational efficiency using a suitable machine learning based model, wherein the future operational efficiency comprises parameter future performance level and cost future performance level.

10. The system of claim 1, wherein the one or more operational parameters associated with one or more cloud asset comprises central processing unit (CPU), used memory, disk read or write per second, disk read byte or write byte per second, network byte received or sent per second, disk free space and the like and wherein the one or more operational values comprises name, device configuration, identifier, percentage usage, size, network consumption, location, date, instance identifier, and the like.

11. A computer implemented method for financially managing cloud resources in a cloud computing environment, the method comprising:
receiving, by a processor, one or more operational parameters associated with one or more cloud assets from a cloud environment;
computing, by the processor, a real time overall operational efficiency of the one or more cloud assets based on the received one or more operational parameters associated with the one or more cloud assets;
determining, by the processor, a modification to be performed to the one or more current operational values associated with each of the one or more operational parameters based on the computed real time overall operational efficiency, wherein the one or more current operational values are determined to be modified to one or more optimal operational values;
generating, by the processor, a recommended operational efficiency of the one or more cloud assets based on the determined modification using the one or more machine learning techniques, wherein the recommended operational efficiency comprises the one or more optimal operational values;
determining, by the processor, whether the recommended operational efficiency of the one or more cloud assets require further optimization of the one or more optimal operational values based on an input trigger, wherein the input trigger is received from a user of the user device, and wherein the input trigger comprises one or more desired configuration of the one or more operational parameters;
generating, by the processor, an updated recommended operational efficiency of the one or more cloud assets based on the determination; and
outputting, by the processor, the generated recommended operational efficiency of the one or more cloud assets on a user interface of a user device.

12. The method of claim 11, wherein computing the real time overall operational efficiency of the one or more cloud assets based on the received one or more operational parameters associated with the one or more cloud assets comprises:
analyzing the received one or more operational parameters associated with the one or more cloud assets using one or more machine learning techniques;
determining last recorded maximum operational value associated with each of the received one or more operational parameters based on the analysis; and
computing the real time overall operational efficiency of the one or more cloud assets based on the determined last recorded maximum operational value associated with each of the received one or more operational parameters.

13. The method of claim 12, wherein determining last recorded maximum operational value associated with each of the received one or more operational parameters based on the analysis comprises:
computing one or more types of aggregation values for the received one or more operational parameters, wherein the one or more types of aggregation values comprises last recorded hundred percentile operational value, average operational value, last recorded maximum operational value, and last recorded eightieth percentile operational value;
classifying the computed one or more types of the aggregation values based on the type of the one or more operational parameter; and
determining the respective last recorded maximum operational value associated with each of the one or more operational parameters based on the classified one or more types of aggregation values.

14. The method of claim 11, wherein determining the modification to be performed to the one or more current operational values associated with each of the one or more operational parameters based on the computed real time overall operational efficiency comprises:
identifying the type of operational parameter associated with the one or more cloud assets based on the received one or more operational parameters;
determining one or more relative parameters associated with the determined type of operational parameters based on other cloud asset information received from the cloud environment;
determining maximum operational capacity value of the identified type of operational parameter based on the determined one or more relative parameters and based on a prestored cloud asset library;
comparing the current operational value of the one or more operational parameters with the determined maximum operational capacity value of the identified type of operational parameter;
determining best suitable range of operational value of the one or more operational parameters based on the comparison and by using a machine learning based asset model;
determining type of modification to be performed to the current operational value of the one or more operational parameters based on the determined best suitable range of the operational value, wherein the type of modification comprises changing size, mode, frequency and allocation of resources associated with the one or more operational parameters.

15. The method of claim 11, wherein generating the recommended operational efficiency of the one or more cloud assets based on the determined modification using the one or more machine learning techniques comprises:
determining a cost estimate model for the modified operational values of the one or more operational parameters based on a suitable machine learning model;
inferring a relationship between each of the modified operational values of the one or more operational parameters;
determining an overall performance score for each of the one or more operational parameters based on the determined cost estimate model and the inferred relationship, wherein the overall performance score indicates the parameter performance level and the cost performance level of the one or more operational parameters; and
generating the recommended operational efficiency of the one or more cloud assets based on the determined overall performance score.

16. The method of claim 11, wherein determining whether the recommended operational efficiency of the one or more cloud assets require further optimization of the one or more optimal operational values based on an input trigger comprises:
parsing the input trigger received from the user of the user device to extract the one or more desired configuration of the one or more operational parameters; and
determining whether the one or more operational values require a modification by comparing the one or more optimal operational values with that of the one or more desired configuration.

17. The method of claim 11, wherein generating the updated recommended operational efficiency of the one or more cloud assets based on the determination comprises:
modifying the one or more operational parameters and the corresponding optimal operational values based on the desired configuration;
determining an updated cost estimate model for the modified optimal operational values of the modified one or more operational parameters based on a suitable machine learning model;
inferring a relationship between each of the modified optimal operational values of the modified one or more operational parameters;
determining an updated overall performance score for each of the modified one or more operational parameters based on the determined updated cost estimate model and the inferred relationship, wherein the updated overall performance score indicates the modified parameter performance level and the modified cost performance level of the modified one or more operational parameters; and
generating the updated recommended operational efficiency of the one or more cloud assets based on the determined updated overall performance score.

18. The method of claim 11, wherein outputting the generated recommended operational efficiency of the one or more cloud assets on the user interface of the user device comprises:
generating one or more visualizations for the recommended operational efficiency; and
displaying the generated one or more visualizations on the user interface of the user device.

19. The method of claim 11, further comprising the step of:
predicting future operational efficiency of the one or more cloud based assets based on the generated recommended operational efficiency and the updated recommended operational efficiency using a suitable machine learning based model, wherein the future operational efficiency comprises parameter future performance level and cost future performance level.

20. A non-transitory computer-readable storage medium having instructions stored therein that when executed by a hardware processor, cause the processor to perform method steps comprising:
receiving one or more operational parameters associated with one or more cloud assets from a cloud environment;
computing a real time overall operational efficiency of the one or more cloud assets based on the received one or more operational parameters associated with the one or more cloud assets;
determining a modification to be performed to the one or more current operational values associated with each of the one or more operational parameters based on the computed real time overall operational efficiency, wherein the one or more current operational values are determined to be modified to one or more optimal operational values;
generating a recommended operational efficiency of the one or more cloud assets based on the determined modification using the one or more machine learning techniques, wherein the recommended operational efficiency comprises the one or more optimal operational values;
determining whether the recommended operational efficiency of the one or more cloud assets require further optimization of the one or more optimal operational values based on an input trigger, wherein the input trigger is received from a user of the user device, and wherein the input trigger comprises one or more desired configuration of the one or more operational parameters;
generating an updated recommended operational efficiency of the one or more cloud assets based on the determination; and
outputting the generated recommended operational efficiency of the one or more cloud assets on a user interface of a user device.
